(19) United States
(12) Patent Application Publication
(10) Pub. No.: US 2011/0294100 A1
(43) Pub. Date: Dec. 1, 2011

(54) PRAYER MAT WITH PRAYER MONITORING SYSTEM

(76) Inventor: Syed Jamal, Moreno Valley, CA (US)

(21) Appl. No.: 12/791,452

(22) Filed: Jun. 1, 2010

(51) Int. Cl. G09B 19/00

(52) U.S. Cl. 434/245

(57) ABSTRACT

The invention satisfies this need. The invention is an elongate prayer mat having a first end and a second end and further comprising (a) a first tactile sensor disposed proximate to the first end; (b) a second tactile sensor disposed proximate to the second end; (c) a third tactile sensor disposed proximate to the second tactile sensor and between the second tactile sensor and the first tactile sensor; (d) a fourth tactile sensor disposed to the right of the third tactile sensor, proximate to the second tactile sensor and between the second tactile sensor and the first tactile sensor; (e) a top layer for concealing each of the tactile sensors; (f) a microprocessor for receiving electrical signals from the tactile sensors and for displaying the progress of prayer steps on a display device.

### BACKGROUND OF THE INVENTION

Prayer mats have been used for centuries by millions of people of various eastern religious faiths. A typical prayer mat is between about 40 inches and about 50 inches in length and between about 20 inches and about 30 inches in width

Those of the Islamic faith are required by Islamic law to use a prayer mat to pray at least five times a day, including five required prayers: a dawn prayer (Fajr), a noon prayer (Zuhr), an afternoon prayer (Asr), a sunset prayer (Maghrib) and a nightfall prayer (Isha).

Each of these five required prayers requires an (1) Iquama step, wherein the praying individual initially stands at one end of the prayer mat, (2) a Ruku step, wherein the praying individual bends at the waist and (3) Attayyatn and Sudjood steps, wherein the praying individual kneels, carries out two or more rakahs and then returns to a standing position. Each rakah involves touching the forehead of the praying individual twice to the opposite end of the prayer mat.

Each of the five required prayers requires a different number of rakahs, and the rakahs are carried out in differing sequences. In the Fajr, the praying individual accomplishes four rakahs, completed in two sets of two rakahs. In the Zuhr, the praying individual carries out twelve rakahs, completed in a sequence of four rakahs, four rakahs, two rakahs and two rakahs. In the Asr, the praying individual carries out eight rakahs accomplished by carrying out a set of four rakahs followed by another set of four rakahs. In the Maghrib, the praying individual carries out seven rakahs, accomplished in a sequence of three rakahs, followed by two rakahs and finished with two additional rakahs. In the Isha, the praying individual carries out seventeen rakahs, accomplished in a rakah sequence of four rakahs, followed by four rakahs, followed by two rakahs, followed by two rakahs, followed by three rakahs, followed by two rakahs.

In addition to the five required prayers, Islamic law encourages additional prayers, including a special Friday prayer (Jumuah) and general prayers which are optional to the praying individual and depend upon his or her will. Each of these non-required prayers have different sequences of prayer steps, including different combinations of rakahs.

As can be readily understood from the above description, it is not easy to keep track of the steps in each of these several prayers, especially the completing of the various rakah sequences. This is especially a problem for the very young and for the elderly.

Accordingly, there is a need for a system which will solve the aforementioned problem.

### SUMMARY OF THE INVENTION

The invention satisfies this need. The invention is an elongate prayer mat having a first end and a second end and further comprising (a) a first tactile sensor disposed proximate to the first end, the first tactile sensor comprising means for perceiving that a user is standing upon the first tactile sensor and generating a first electrical signal; (b) a second tactile sensor disposed proximate to the second end, the second tactile sensor comprising means for perceiving that a user is pressing upon the second tactile sensor and for generating a second electrical signal; (c) a third tactile sensor disposed proximate to the second tactile sensor and between the second tactile sensor and the first tactile sensor, the third tactile sensor comprising means for perceiving that a user is pressing upon the third tactile sensor and for generating a third electrical signal; (d) a fourth tactile sensor disposed to the right of the third tactile sensor, proximate to the second tactile sensor and between the second tactile sensor and the first tactile sensor, the fourth tactile sensor comprising means for perceiving that a user is pressing upon the fourth tactile sensor and for generating a fourth electrical signal; (e) a top layer for concealing each of the tactile sensors; (f) a microprocessor for receiving the first, second, third and fourth electrical signals and, based upon those electrical signals, for displaying the progress of prayer steps on a display device.

In a preferred embodiment, the microprocessor is programmed to alternatively display the steps of at least five different sets of prayer steps.

In another preferred embodiment of the invention, the prayer mat further comprises a reversible visual display cover for alternatively concealing and revealing the display device.

### DRAWINGS

These features, aspects and advantages of the present invention will become better understood with regard to the following description, appended claims and accompanying figures where:

FIG. 1 is a perspective view of a prayer mat having features of the invention showing a visual display in an uncovered configuration;

FIG. 2 is a perspective view of the prayer mat illustrated in FIG. 1 showing the visual display hidden by a visual display cover;

FIG. 3 is a perspective view of the prayer mat illustrated in FIG. 1, showing a top layer opened away from the remainder of the prayer mat;

FIG. 4 is a plan view of a typical display module useable in the invention;

FIG. 5 is an electrical diagram illustrating electrical connections useable in the invention;

FIG. 6 is an electrical diagram illustrating electrical connections for the monitoring of a first prayer;

FIG. 7 is an electrical diagram illustrating electrical connections for the monitoring of a second prayer;

FIG. 8 is an electrical diagram illustrating electrical connections for the monitoring of a third prayer;

FIG. 9 is an electrical diagram illustrating electrical connections for the monitoring of a fourth prayer; and

FIG. 10 is an electrical diagram illustrating electrical connections for the monitoring of a fifth prayer.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

As used herein, except where the context requires otherwise, the term “comprise” and variations of the term, such as “comprising,” “comprises” and “comprised” are not intended to exclude other additives, components, integers or steps. Thus, throughout this specification, unless the context requires otherwise, the words “comprise”, “comprising” and the like, are to be construed in an inclusive sense as opposed to an exclusive sense, that is to say, in the sense of “including, but not limited to”.

As depicted in the Figures, all dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by its intended use.

The invention is an elongate prayer mat 10 having the capability of alternatively monitoring different prayer steps. One example embodiment of the invention 10 is illustrated in the drawings.

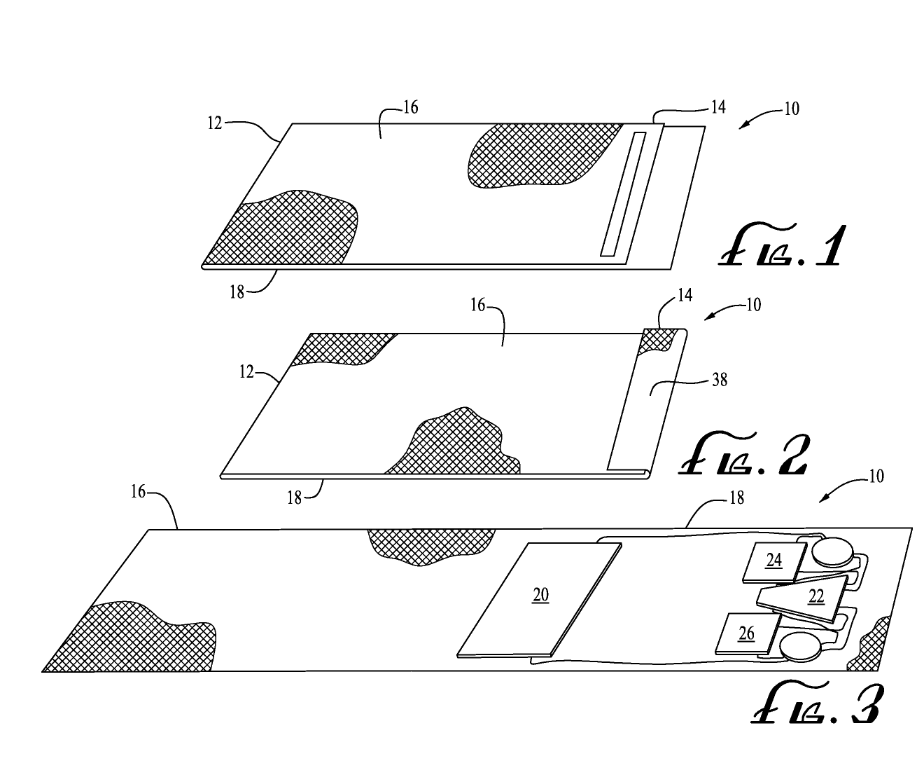

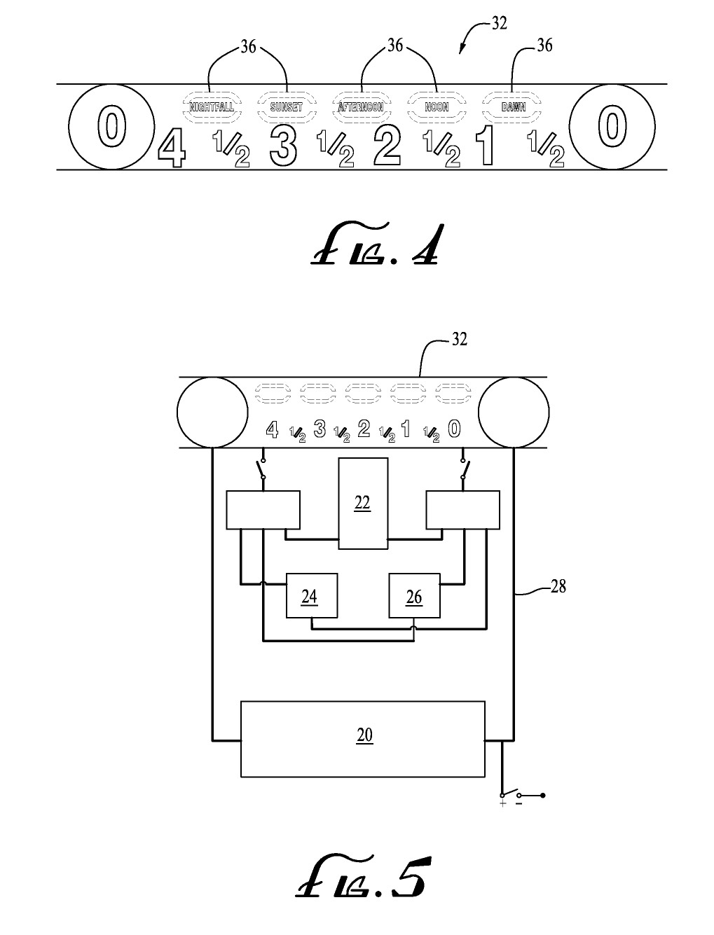

As best seen in FIGS. 1-3, the elongate prayer mat 10 has a first end 12, a second end 14, a bottom layer 16 and a top layer 18.

In the embodiment illustrated in the drawings, in between the bottom layer 16 and the top layer 18 are disposed a first tactile sensor 20, a second tactile sensor 22, a third tactile sensor 24 and a fourth tactile sensor 26. Each tactile sensors 20, 22, 24 and 26 is adapted to perceive that a portion of a user is pressing upon that tactile sensor.

The first tactile sensor 20 is disposed proximate to the first end 12 and is adapted for perceiving that a user is standing upon the first tactile sensor 20.

The second tactile sensor 22 is disposed proximate to the second end 14 and is adapted for perceiving that a user is pressing upon the second tactile sensor 22. The second tactile sensor 22 is adapted to perceive the pressing on the second tactile sensor 22 of a user's forehead.

The third tactile sensor 24 is disposed proximate to the second tactile sensor 20 and typically between the second tactile sensor 22 and the first tactile sensor 20. The third tactile sensor 24 is adapted to perceive that a user is pressing upon the third tactile sensor 24, and is located to perceive the pressing upon the third tactile sensor 24 of a user's left hand.

The fourth tactile sensor 26 is disposed to the right of the third tactile sensor 24, proximate to the second tactile sensor 22 and typically between the second tactile sensor 22 and the first tactile sensor 20. The fourth tactile sensor 26 is adapted for perceiving that a user is pressing upon the fourth tactile sensor 26, and is positioned to perceive the pressing of the fourth tactile sensor 26 by the right hand of a user.

Each of the tactile sensors 20, 22, 24 and 26 generates an electrical signal indicating pressure from a user on that tactile sensor. The first tactile sensor 20 generates a first electrical signal, the second tactile sensor 22 generates a second electrical signal, the third tactile sensor 24 generates a third electrical signal and the fourth tactile sensor 26 generates a fourth electrical signal.

The elongate prayer mat 10 further comprises electrical circuitry 28 for connecting each of the electrical signals to a microprocessor 30. The microprocessor 30 is adapted for receiving the first, second, third and fourth electrical signals and, based upon those electrical signals, for displaying the progress of prayer steps on a display device 32.

The microprocessor 30 can be any of the many microprocessors known to those of skill in the art. In the embodiment illustrated in the drawings, the microprocessor 30 comprises a plurality of subprocessors 34 which accept and interpret each of the electrical signals from the tactile sensors 20, 22, 24 and 26.

The display device 32 can be any of a wide variety of display devices. In the embodiment illustrated in the drawings, as best seen in FIG. 4, the display device 32 can be an elongate electronic device screen.

In the embodiment illustrated in FIG. 4, an indicator on the far right side of the display device 32 displays the total number of steps performed in a required prayer. Such indicator on the right-most side of the display device 32 therefore displays an integer between 0 and 17. An indicator on the left-most side of the display device displays the number of steps carried out in a general prayer, and will typically display an integer between 0 and several hundred.

For each of the five required Islamic prayers, the central portion of the display device 32 displays the number of rakahs performed in each of the five required Islamic prayers. Since each rakah requires the praying individual to touch his or her forehead to the prayer mat twice, each time the praying individual touches his or her forehead to the mat, the central portion of the display device 32 increases by an interval of one half. Since all Islamic prayers require rakahs carried out in sets of four or less, the largest number displayed on the central portion of the display device is the number four.

Also in the embodiment illustrated in the drawings, the elongate prayer mat 10 further comprises switch activators 36 for directing the display device 32 to display the steps of a selected prayer. As illustrated in FIG. 4, such switch activators 36 can be provided by buttons or pressure sensitive areas on the display device 32. A reset activator and a general prayer activator are also typically provided, although such activators are not shown in the drawings.

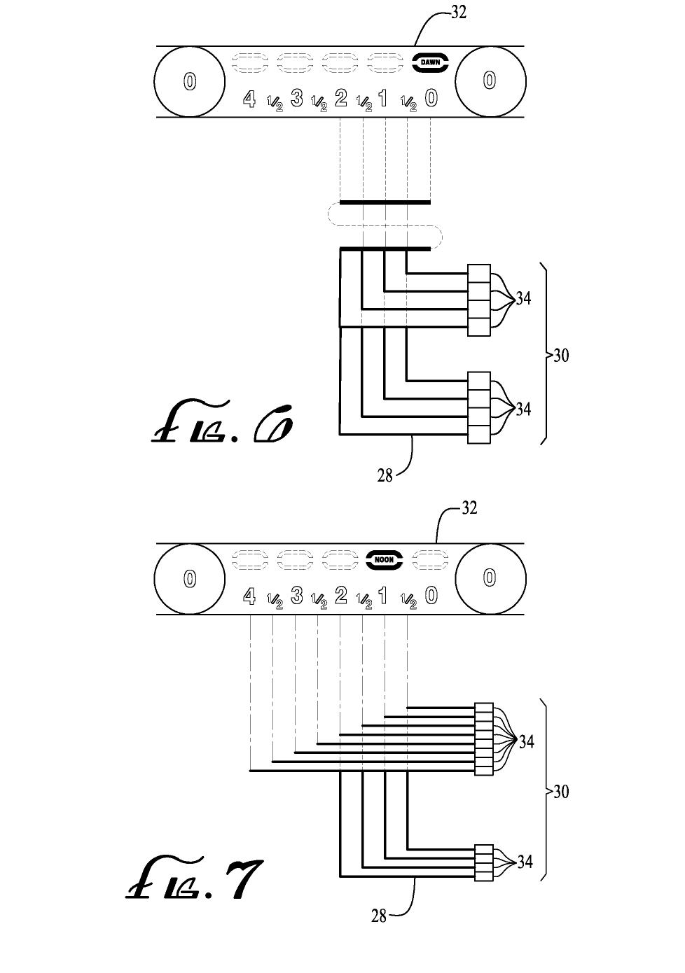

FIG. 5 is a simplified electrical drawing generally indicating how the four tactile sensors 20, 22, 24 and 26 are electrically connected to the microprocessor 30 and to the display device 32.

FIG. 6 illustrates in detail how the subprocessors 34 within the microprocessor 30 interact with the display device 32 for a dawn prayer. The subprocessors 34 are connected to the display device 32 in such a way that the central portion of the display device 32 displays each half of the prayer steps between 0 and 2. In this way, the display device 32 monitors the progress of the dawn prayer as the praying individual completes two separate sets of two rakahs each. The subprocessors 34 are connected to the display 32 device in such a way that the indicator at the right-most side of the display device 32 monitors the total number of rakahs completed by the praying individual between 0 and 4.

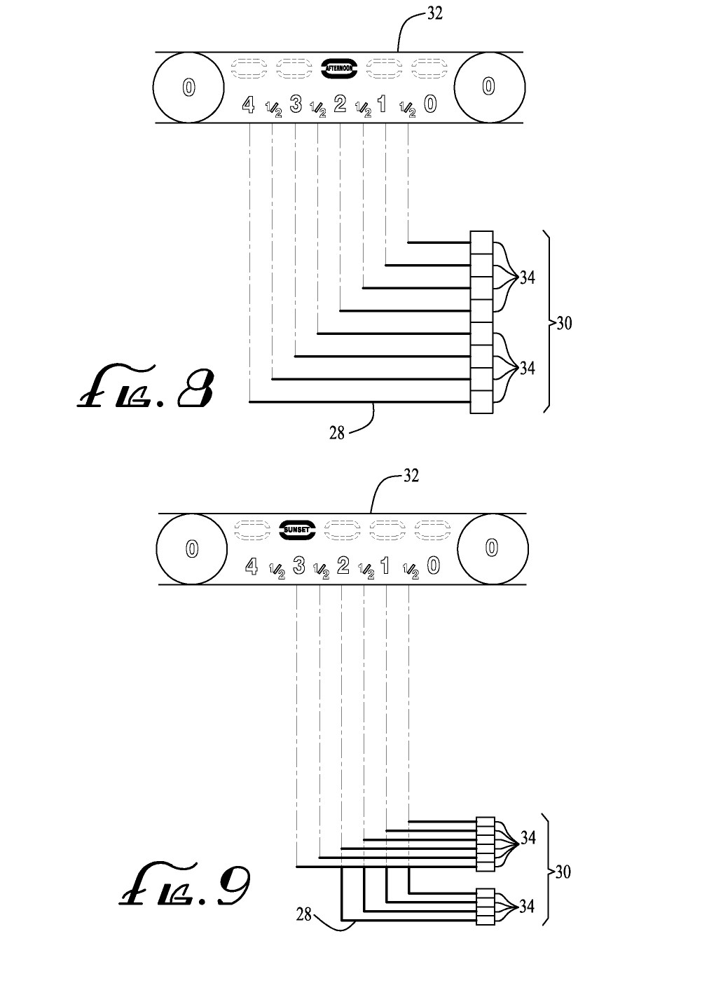

FIG. 7 illustrates in detail how the subprocessors 34 within the microprocessor 30 interact with the display device 32 for a noon prayer. The subprocessors 34 are connected to the display device 32 in such a way that the central portion of the display device 32 displays each half of the prayer steps between 0 and 4. In this way, the display device 32 monitors the progress of the noon prayer as the praying individual completes two separate sets of four rakahs each and two separate sets of two rakahs each. The subprocessors 34 are connected to the display device 32 in such a way that the indicator at the right-most side of the display device 32 monitors the total number of rakahs completed by the praying individual between 0 and 12.

FIG. 8 illustrates in detail how the subprocessors 34 within the microprocessor 30 interact with the display device 32 for a afternoon prayer. The subprocessors 34 are connected to the display device 32 in such a way that the central portion of the display device 32 displays each half of the prayer steps between 0 and 4. In this way, the display device 32 monitors the progress of the afternoon prayer as the praying individual completes two sets of four rakahs each. The subprocessors 34 are connected to the display device 32 in such a way that the indicator at the right-most side of the display device 32 monitors the total number of rakahs completed by the praying individual between 0 and 8.

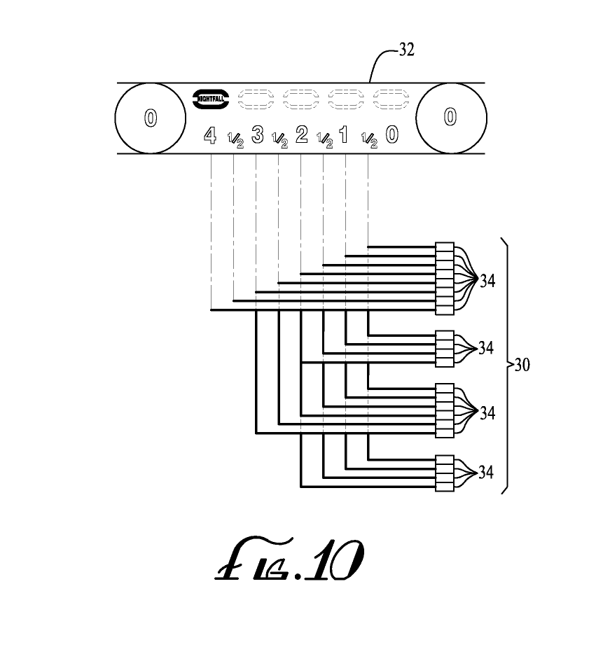

FIG. 9 illustrates in detail how the subprocessors 34 within the microprocessor 30 interact with the display device 32 for a sunset prayer. The subprocessors 34 are connected to the display device 32 in such a way that the central portion of the display device 32 displays each half of the prayer s between 0 and 3. In this way, the display device 32 monitors the progress of the sunset prayer as the praying individual completes a single set of three rakahs and two separate sets of two rakahs each. The subprocessors 34 are connected to the display device 32 in such a way that the indicator at the right-most side of the display device 32 monitors the total number of rakahs completed by the praying individual between 0 and 7.

FIG. 10 illustrates in detail how the subprocessors 34 within the microprocessor 30 interact with the display device 32 for a nightfall prayer. The subprocessors 34 are connected to the display device 32 in such a way that the central portion of the display device 32 displays each half of the prayer steps between 0 and 4. In this way, the display device 32 monitors the progress of the dawn prayer as the praying individual completes two separate sets of four rakahs each, two separate sets of two rakahs each, a single set of three rakahs and a final separate set of two rakahs. The subprocessors 34 are connected to the display device 32 in such a way that the indicator at the right-most side of the display device 32 monitors the total number of rakahs completed by the praying individual between 0 and 17.

In the embodiment of the invention illustrated in the drawings, the elongate prayer mat 10 further comprises a reversible visual display cover 38 for alternatively covering the display device 32 and uncovering the display device 32. In the embodiment illustrated in the drawings, best seen in FIGS. 1 and 2, the reversible visual display cover 38 is provided by a flap of material attached to the first end of the bottom layer 16 which can be conveniently folded back atop the display device 32 to cover and conceal the display device 32. The reversible visual display cover 38 can be provided by other structures as well.

The reversible visual display cover 38 allows a praying individual who is confident of keeping track of prayer steps in his or her head to conceal the display device 32 and conduct his or her prayers without the monitoring function of the prayer mat 10. However, for those with a memory or concentration difficulty, such as the very young or the elderly, the reversible visual display cover 38 can be conveniently removed to reveal the display device 32 and to allow the praying individual to monitor his or her prayer with the full functionality of the invention.

The invention provides a convenient way of praying individuals to monitor the many complex steps of Islamic prayers and similar prayers of other religions. Embodiments of the invention having a reversible visual display cover allow the praying individual to alternatively ignore the functionality of the invention and use of the prayer mat in the traditional way (i.e., keeping track of the prayer steps in his or her head).

Having thus described the invention, it should be apparent that numerous structural modifications and adaptations may be resorted to without departing from the scope and fair meaning of the instant invention as set forth hereinabove and as described hereinbelow by the claims.

What is claimed is:

1. An elongate prayer mat having a first end and a second end and further comprising:
(a) a first tactile sensor disposed proximate to the first end, the first tactile sensor comprising means for perceiving that a user is standing upon the first tactile sensor and generating a first electrical signal;
(b) a second tactile sensor disposed proximate to the second end, the second tactile sensor comprising means for perceiving that a user is pressing upon the second tactile sensor and for generating a second electrical signal;
(c) a third tactile sensor disposed proximate to the second tactile sensor and between the second tactile sensor and the first tactile sensor, the third tactile sensor comprising means for perceiving that a user is pressing upon the third tactile sensor and for generating a third electrical signal;
(d) a fourth tactile sensor disposed to the right of the third tactile sensor, proximate to the second tactile sensor and between the second tactile sensor and the first tactile sensor, the fourth tactile sensor comprising means for perceiving that a user is pressing upon the fourth tactile sensor and for generating a fourth electrical signal;
(e) a top layer for concealing each of the tactile sensors; and
(f) a microprocessor for receiving the first, second, third and fourth electrical signals and, based upon those electrical signals, for displaying the progress of prayer steps on a display device, the microprocessor being programmed to alternatively display the steps of at least five different sets of prayer steps.

2. The elongate prayer mat of claim 1 wherein the microprocessor is programmed to alternatively display the steps of a Fajr prayer, a Zuhr prayer, an Asr prayer, a Maghrib prayer and an Isha prayer.

3. The elongate prayer mat of claim 1 wherein the microprocessor is programmed to alternatively display the steps of a general prayer.

4. The elongate prayer mat of claim 1 further comprising switch activators for directing the microprocessor to display the steps of a selected prayer.

5. The elongate prayer mat of claim 1 further comprising a reversible visual display cover for alternatively covering the display device and uncovering the display device.

6. An elongate prayer mat having a first end and a second end and further comprising:
(a) a first tactile sensor disposed proximate to the first end, the first tactile sensor comprising means for perceiving that a user is standing upon the first tactile sensor and generating a first electrical signal;
(b) a second tactile sensor disposed proximate to the second end, the second tactile sensor comprising means for perceiving that a user is pressing upon the second tactile sensor and for generating a second electrical signal;
(c) a third tactile sensor disposed proximate to the second tactile sensor and between the second tactile sensor and the first tactile sensor, the third tactile sensor comprising means for perceiving that a user is pressing upon the third tactile sensor and for generating a third electrical signal;
(d) a fourth tactile sensor disposed to the right of the third tactile sensor, proximate to the second tactile sensor and between the second tactile sensor and the first tactile sensor, the fourth tactile sensor comprising means for perceiving that a user is pressing upon the fourth tactile sensor and for generating a fourth electrical signal;
(e) a top layer for concealing each of the tactile sensors;
(f) a reversible visual display cover for alternatively covering the display device and uncovering the display device; and
(g) a microprocessor for receiving the first, second, third and fourth electrical signals and, based upon those electrical signals, for displaying the progress of prayer steps on a display device, the microprocessor being programmed to alternatively display the steps of at least five different sets of prayer steps;
wherein the microprocessor is programmed to alternatively display the steps of a Fajr prayer, a Zuhr prayer, an Asr prayer, a Maghrib prayer and an Isha prayer.

7. The elongate prayer mat of claim 6 wherein the microprocessor is programmed to alternatively display the steps of a general prayer.
